(19) United States
(12) Patent Application Publication
(10) Pub. No.: US 2004/0166745 A1
(43) Pub. Date: Aug. 26, 2004

(54) U-DO Board

(76) Inventor: Udo Lothar Dieter Romstedt, Lake Wales, FL (US)

Correspondence Address: UDO L.D. ROMSTEDT, 1299 Heenan Place, Kenora, ON, P9N 2Y9, CA

(21) Appl. No.: 10/370,874

(22) Filed: Feb. 24, 2003

(51) Int. Cl. H01R 9/22

(52) U.S. Cl. 439/894

(57) ABSTRACT

This invention is a simple board or box of any size or shape to which all in and outputs from all components like TV, VCR, DVD, Tuner, Computer etc. are fed into the rear of the board or box and facing out of the board or box on its front side. The board or box can be placed at a convenient easy to reach location and all components can be connected which each other with a simple 7 inch cord. Of course, with todays technology these connections could be made via wireless remote control instead of the cord, which is a matter of production cost.

### SUMMARY OF INVENTION

This invention allows a person to have one control board which can connect all of his units with each other, inside or outside of an entertainment cabinet. The board can be of any size or shape and be constructed from any kind of material. This is a cosmetic and convenience matter.

The U-DO Board can be a plain ¾ inch board or can have the shape and size of a simple VCR and be placed in an entertainment cabinet with all other components. As an example, if the U-DO Board is build in the shape of an VCR, where you now find the controls of the VCR you find rows of RCA's in & out connectors, S-Video connectors, USB ports and in & out puts of other electronic components. The connectors you are facing, represents all the in & outputs of your electronic components, which are located at the back of each unit. With a simple RCA patch cord, not longer than 12 inches, you are able to connect any of your units which each other. Another example is, if you just took some pictures with your video camera and would like to see how they look on a TV, just connect the camera to your U-DO Board, because one of the connectors will lead to your TV set. Another advantage of the U-DO Board is, that you would never be short of in and out connections on any of your electronic units. As an example: On your tuner all in & out connections are in use, but you would like to connect an additional unit. Presently you would have to unplug one of the units connected to your tuner and connect the other at the rear of the tuner. The same would apply in reverse. With the U-DO Board you can achieve the same task without even touching the tuner.

With today's technologies, instead of using a patch cord for connections, maybe a remote control could be used. This of course does not change the basics of my invention.

### DETAILED DESCRIPTION OF THE INVENTION

The U-DO Board could be manufactured from any type of material, wood, metal, plastic etc. and could be of any shape or size. It would be a simple board held in an upright position. Holes are drilled through this board to allow an RCA coupler to be pushed through and held in place, so half of the coupler sticks out on one side of the board and the other on the opposite side. This can be done not only with an RCA coupler but other couplers used for connecting two cables. The number of holes being drilled depends on the size of the board to be manufactured. A person now can feed all the in & out puts, which are located at the rear of electronic components and devises, into one side of the board and then connect any or all of the components which each other on the front of the board, using a short connecting cord.

This is the way my “home made” board looks and works. For the market place, a metal box with a dimension of 12×3×4 would look much more appealing. Manufacturing such box would not involve the use of “couplers”, but the in and out connection would be joined by a wire.

LABELING: The manufacturer should label the connection on the in and out put of the U-DO Board for the most used electronic components and devices in use today, but some connections should just be numbered for the user to add additional equipment to the board and use these numbers for his own reference.

### BACKGROUND OF INVENTION

With more and more electronic devices and/or components showing up in private homes and places of business, there is a problem of inter connecting some or all of the devices with each other in a simple way. Most, if not all electronic equipment have the in & outputs in the rear of the unit. To connect the units which each other, somehow you have to get to the rear of your unit to make the connection, which could be difficult, especially if the units are in an entertainment cabinet. This could involve moving furniture, getting tangled up in cords and the use of a flashlight to make the desired connection.

Having unsuccessfully searched for years to find a devise which would eliminate this problem, I have build myself such devise for my own use and named it U-DO Board.

1. What I claim as my invention is to manufacture an electronic devise which enables me to connect various components like, tv, vcr, dvd player, tuner, tape deck, receivers, computers etc. with each other from one local location, regardless where the components are located.
